(19) United States
(12) Patent Application Publication
(10) Pub. No.: US 2007/0197726 A1
(43) Pub. Date: Aug. 23, 2007

(54) Fluoroplastics Containing Fluorocarbon-Silicone Elastomers

(76) Inventors: Igor Chorvath, Midland, MI (US); Lauren Marie Tonge, Sanford, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 11/596,792

(22) PCT Filed: Jun. 1, 2005
(86) PCT No.: PCT/US05/19023

§ 371 Date: Nov. 16, 2006

Related U.S. Application Data
(60) Provisional application No. 60/584,305, filed on Jun. 30, 2004.

(51) Int. Cl. C08F 214/18

(52) U.S. Cl. 525/105

(57) ABSTRACT

Fluoroplastic compositions comprising the reaction product from mixing: i) a fluorocarbon-silicone elastomeric base, ii) a fluoroplastic resin, and iii) a fluorocarbon elastomer cure agent, are disclosed. The fluoroplastic compositions and the manufactured articles made therefrom have improved impact or flexural properties.

### CROSS REFERENCE TO RELATED APPLICATIONS

This application claims priority to U.S. Patent Application No. 60/584,305 as filed, Jun. 30, 2004.

### FIELD OF THE INVENTION

The present invention provides fluoroplastic compositions comprising the reaction product from mixing; i) a fluorocarbon—silicone elastomeric base, ii) a fluoroplastic resin, and iii) a fluorocarbon elastomer cure agent.

### BACKGROUND OF THE INVENTION

Fluoroplastics are commonly selected to prepare various thermoplastic articles for use in harsh chemical and/or thermal conditions. For example many automotive hoses, gaskets, and seals are prepared from fluoroplastics. However, in some of these applications, there is a need to improve the impact resistance of the fluoroplastic, or alternatively, to improve the flexural modulus of the fluoroplastic.

One possible approach to improving the impact resistance of the fluoroplastic is to incorporate a rubbery or elastomeric material into the fluoroplastic. For example, fluorocarbon elastomers can be incorporated into the fluoroplastic. However, this approach can be expensive, since it relies on the addition of a relatively expensive raw material to another. Alternative approaches have been considered such as the incorporation of a silicone elastomer into a fluoroplastic to improve the impact resistance of the fluoroplastic. However, incorporating a silicone elastomer into the fluoroplastic is not easily achieved because of the inherent incompatibilities between two such phases.

Fluoroplastics containing silicones are described in U.S. Application No. 60/476767. These fluoroplastics are prepared by first mixing a fluorocarbon resin with a compatibilizer, then adding a curable organopolysiloxane with a radical initiator, and vulcanizing the organopolysiloxane in the mixture. The fluoroplastic taught therein can be processed by various techniques, such as extrusion, vacuum forming, injection molding, blow molding or compression molding, to fabricate plastic parts. The resulting fabricated parts can be re-processed (recycled) with little or no degradation of mechanical properties.

Fluoroplastics containing silicones are also described in U.S. Ser. No. 6,015,858, which teaches the use of a platinum catalyst to cure the silicone portion of the compositions by dynamic vulcanization techniques.

The present inventors have discovered fluoroplastic compositions containing silicones having improved or comparable physical properties, when compared to the unmodified fluoroplastic compositions. The silicone portion of the compositions are provided by the addition of a fluorocarbon elastomer base containing silicones such as those described in U.S. Pat. Nos. 4,942,202, 4,985,483 5,010,137, 5,171,787, and 5,350,804, WO2003/104322 and WO2003/104323. The resulting fluoroplastic compositions have improved physical properties in some instances when compared to the unmodified fluoroplastic alone. The resulting fluoroplastic compositions are more economical than typical fluoroplastics because of the reduced concentration of the fluoropolymer in the composition.

### SUMMARY OF THE INVENTION

The present invention provides fluoroplastic compositions comprising the reaction product from mixing;

i) a fluorocarbon—silicone elastomeric base,

ii) a fluoroplastic resin, and

iii) a fluorocarbon elastomer cure agent.

The fluorocarbon—silicone elastomeric base can be prepared by a process comprising mixing a curable organopolysiloxane with a fluorocarbon elastomer and then vulcanizing the organopolysiloxane to form the fluorocarbon—silicone elastomeric base.

The present invention also relates to articles of manufacture comprising the compositions taught herein.

### DETAILED DESCRIPTION OF THE INVENTION

Component (i) of the present invention is a fluorocarbon—silicone elastomeric base. As used herein “a fluorocarbon—silicone elastomeric base” refers to a fluorocarbon elastomer composition containing discrete cured silicone rubber particles, wherein the fluorocarbon elastomer portion can be cured to form a fluorocarbon—silicone elastomeric rubber. The fluorocarbon elastomer can be any fluorocarbon elastomer commonly referred to or designated as an FKM. The silicone rubber is any organopolysiloxane that has been cured to form a silicone rubber. The fluorocarbon—silicone elastomeric base can be prepared by any known process, such as blending cured silicone particles in a fluorocarbon elastomer as described in U.S. Pat. Nos. 4,985,483 and 5,350,804, which are hereby incorporated by reference. Preferably, the fluorocarbon—silicone elastomeric base is prepared by a process comprising mixing a curable organopolysiloxane with a fluorocarbon elastomer (FKM) and then vulcanizing the organopolysiloxane to form the fluorocarbon—silicone elastomeric base, such as those processes described in U.S. Pat. Nos. 4,942,202, 5,010,137, and 5,171,787, WO2003/104322 and WO2003/104323, which are hereby incorporated by reference.

Typically the fluorocarbon—silicone elastomeric base composition (i) can be prepared by a method comprising:

(I) mixing
(A) a fluorocarbon elastomer with
(B) an optional compatibilizer,
(C) an optional catalyst
(D) a silicone base comprising a curable organopolysiloxane,
(E), an optional crosslinking agent
(F) a cure agent in an amount sufficient to cure said organopolysiloxane, and

(II) vulcanizing the organopolysiloxane,

wherein the weight ratio of fluorocarbon elastomer to silicone base in the elastomeric base composition ranges from 95:5 to 30:70.

Component (A) in the fluorocarbon—silicone elastomeric base composition having a glass transition temperature (Tg) below room temperature, alternatively below 23° C., alternatively, below 15° C., alternatively below 0° C. “Glass transition temperature”, means the temperature at which a polymer changes from a glassy vitreous state to a plastic state. The glass transition temperature can be determined by conventional methods such as dynamic mechanical analysis (DMA) and Differential Scanning Calorimetry (DSC). Fluorocarbon elastomers are well known in the art and many are commercially available. Fluorocarbon elastomers are commonly denoted as FKM. Thus, the fluorocarbon elastomers, component (A), are abbreviated FKM herein. Representative, non-limiting examples of the FKM elastomers, and FKM polymers, useful as component (A) in the present invention can be found in summary articles of this class of materials such as in: “Encyclopedia of Chemical Technology”, by Kirk-Othmer, 4^{th} Edition, Vol. 8, pages 990-1005, John Wiley & Sons, NY; “Polymeric Materials Encyclopedia”, by J. C. Salamone, Vol. 4, pages 2495-2498, CRC Press, NY; “Encyclopedia of Polymer Science and Engineering, 2^{nd} Edition, Vol. 7, pages 257-269,; and “Fluoroelastomers”, by K.-L. Ring, A. Leder, and K Sakota, Chemical Economics Handbook-SRI International 2000, Elastomers-Specialty 525.6000A, all of which are hereby incorporated by reference.

Thus, the fluorocarbon elastomers maybe composed of combinations of the following fluorine-containing monomers: vinylidene fluoride, hexafluoropropene, pentafluoropropene, trifluoroethylene, trifluorochloroethylene, tetrafluoroethylene, vinyl fluoride, perfluoro(methylvinylether) and perfluoro(propylvinylidene). These monomers can also be copolymerized with copolymerizable monomers including vinyl compounds such as acrylate esters, olefin compounds such as propylene, and diene compounds. Examples of the fluorine rubbers produced in this way include vinylidene fluoride-hexafluoropropylene copolymer, vinylidene fluoride-hexafluoropropyelene-tetrafluoroethylene terpolymer, tetrafluoroethylene-propylene co-polymer, and tetrafluoroethylene-vinylidene fluoride-propylene terpolymer.

Alternatively, the fluorocarbon elastomer comprises a copolymer of vinylidene fluoride and hexafluoropropene, a terpolymer of vinylidene fluoride, hexafluoropropene, and tetrafluoroethene, or a terpolymer of vinylidene fluoride, tetrafluoroethene, and perfluoromethylvinyl ether.

Representative, non-limiting, commercially available materials useful as component (A) include the fluorocarbon elastomers sold under the tradenames of: VITON® by Dupont-Dow Elastomers, (Wilmington, Del.); Dyneon™ by Dyneon LLC (Oakdale, Minn.); Tecnoflon® by Solvay Solexis, Inc. (Bollate, Italy); Aflas™ by Asahi Glass Co. Ltd. (Ichihara, Chiba Prefecture); and Dai-el™ by Daikin Industries Ltd. (Settsu, Osaka Prefecture).

Compatibilizer (B) can be selected from any hydrocarbon, organosiloxane, fluorocarbon, or combinations thereof that would be expected to enhance the mixing of the silicone base (D) with the FKM elastomer (A). Generally, the compatibilizer can be one of two types. In a first embodiment, herein referred to as a physical compatibilizer, the compatibilizer is selected from any hydrocarbon, organosiloxane, fluorocarbon, or combinations thereof, that would not be expected to react with the FKM (A), yet still enhance the mixing of the FKM with the silicone base. In a second embodiment herein referred to as a chemical compatibilizer, the compatibilizer is selected from any hydrocarbon, organosiloxane, or fluorocarbon or combinations thereof that could react chemically with the FKM. However in either embodiment, the compatibilizer must not prevent the dynamic cure of the organopolysiloxane component, described infra.

In the physical compatibilizer embodiment, the compatibilizer (B) can be selected from any compatibilizer known in the art to enhance the mixing of a silicone base with a FKM elastomer. Typically, such compatibilizers are the reaction product of a organopolysiloxane and a fluorocarbon polymer. Representative non-limiting examples of such compatibilizers are described in U.S. Pat. Nos. 5,554,689 and 6,035,780, WO2003/104322 and WO2003/104323 which are incorporated by reference herein. Alternatively, the compatibilizer can be selected from a fluorocarbon that can react with catalyst (C), or alternatively cure agent (F), during the mixing process.

In the chemical compatibilizer embodiment, typically the compatibilizer (B) can be selected from (B′) organic (i.e., non-silicone) compounds which contain 2 or more olefin groups, (B″) organopolysiloxanes containing at least 2 alkenyl groups,(B″′) olefin-functional silanes which also contain at least one hydrolyzable group or at least one hydroxyl group attached to a silicon atom thereof, (B″″) an organopolysiloxane having at least one organofunctional groups selected from amine, amide, isocyanurate, phenol, acrylate, epoxy, and thiol groups, and any combinations of (B′), (B″), (B′″), and (B″″).

Organic compatibilizer (B′) can be illustrated by compounds such as diallyphthalate, triallyl isocyanurate, 2,4,6-triallyloxy-1,3,5-triazine, triallyl trimesate, 1,5-hexadiene, 1,7-octadiene, 2,2′-diallylbisphenol A, N,N′-diallyl tartardiamide, diallylurea, diallyl succinate and divinyl sulfone, inter alia.

Compatibilizer (B″) may be selected from linear, branched or cyclic organopolysiloxanes having at least 2 alkenyl groups in the molecule. Examples of such organopolysiloxanes include divinyltetramethyldisiloxane, cyclotrimethyltrivinyltrisiloxane, cyclo-tetramethyltetravinyltetrasiloxane, hydroxy end-blocked polymethylvinylsiloxane, hydroxy terminated polymethylvinylsiloxane-co-polydimethylsiloxane, dimethylvinylsiloxy terminated polydimethylsiloxane, tetrakis(dimethylvinylsiloxy)silane and tris(dimethylvinylsiloxy)phenylsilane. Alternatively, compatibilizer (B″) is a hydroxy terminated polymethylvinylsiloxane [HO(MeViSiO)ₓH] oligomer having a viscosity of about 25-100 m Pa-s, containing 25-35% vinyl groups and 2-4% silicon-bonded hydroxy groups.

Compatibilizer (B′″) is a silane which contains at least one alkylene group, typically comprising vinylic unsaturation, as well as at least one silicon-bonded moiety selected from hydrolyzable groups or a hydroxyl group. Suitable hydrolyzable groups include alkoxy, aryloxy, acyloxy or amido groups. Examples of such silanes are vinyltriethoxysilane, vinyltrimethoxysilane, hexenyltriethoxysilane, hexenyltrimethoxy, methylvinyldisilanol, octenyltriethoxysilane, vinyltriacetoxysilane, vinyltris(2-ethoxyethoxy)silane, methylvinylbis(N-methylacetamido)silane, methylvinyldisilanol.

Compatibilizer (B″″) is an organopolysiloxane having at least one organofunctional groups selected from amine, amide, isocyanurate, phenol, acrylate, epoxy, and thiol groups.

It is possible that a portion of the curable organopolysiloxane of the silicone base component (D) described infra, can also function as a compatibilizer. For example, a catalyst (C) can be used to first react a portion of the curable organopolysiloxane of silicone base (D) with the FKM elastomer to produce a modified FKM elastomer. The modified FKM elastomer is then further mixed with the remaining silicone base (D) containing the curable organopolysiloxane, and the organopolysiloxane is dynamically vulcanized as described infra.

The amount of compatibilizer used per 100 parts of FKM elastomer can be determined by routine experimentation. Typically, 0.05 to 10 parts by weight, or alternatively 0.05 to 15 parts by weight, or alternatively 0.1 to 5 parts of the compatibilizer is used for each 100 parts of FKM elastomer.

Optional component (C) is a catalyst. Typically, it is a radical initiator selected from any organic compound which is known in the art to generate free radicals at elevated temperatures. The initiator is not specifically limited and may be any of the known azo or diazo compounds, such as 2,2′-azobisisobutyronitrile, but it is preferably selected from organic peroxides such as hydroperoxides, diacyl peroxides, ketone peroxides, peroxyesters, dialkyl peroxides, peroxydicarbonates, peroxyketals, peroxy acids, acyl alkylsulfonyl peroxides and alkyl monoperoxydicarbonates. A key requirement, however, is that the half life of the initiator be short enough so as to promote reaction of compatibilizer (B) with the FKM elastomer (A) within the time and temperature constraints of the fluorocarbon—silicone elastomeric base composition (i) reaction step (I). The modification temperature, in turn, depends upon the type of FKM elastomer and compatibilizer chosen and is typically as low as practical consistent with uniform mixing of components (A) through (C). Specific examples of suitable peroxides which may be used according to the method of the present invention include; 2,5-dimethyl-2,5-di(tert-butylperoxy)hexane, benzoyl peroxide, dicumyl peroxide, t-butyl peroxy O-toluate, cyclic peroxyketal, t-butyl hydroperoxide, t-butyl peroxypivalate, lauroyl peroxide and t-amyl peroxy 2-ethylhexanoate, di-t-butyl peroxide, 1,3-bis(t-butylperoxyisopropyl) benzene, 2,2,4-trimethylpentyl-2-hydroperoxide, 2,5-bis(t-butylperoxy)-2,5-dimethylhexyne-3, t-butyl-peroxy-3,5,5-trimethylhexanoate, cumene hydroperoxide, t-butyl peroxybenzoate and diisopropylbenzene mono hydroperoxide, inter alia. Less than 2 part by weight of peroxide per 100 parts of FKM elastomer is typically used. Alternatively, 0.05 to 1 parts, and 0.2 to 0.7 parts, can also be employed.

Component (D) is a silicone base comprising a curable organopolysiloxane (D′) and optionally, a filler (D″). A curable organopolysiloxane is defined herein as any organopolysiloxane having at least two curable groups present in its molecule. Organopolysiloxanes are well known in the art and are often designated as comprising any number of M units (R₃SiO_{0.5}), D units (R₂SiO), T units (RSiO_{1.5}), or Q units (SiO₂) where R is independently any monovalent hydrocarbon group. Alternatively, organopolysiloxanes are often described as having the following general formula; [RₘSi(O)_{4-m/2}]ₙ, where R is independently any monovalent hydrocarbon group and m=1−3, and n is at least two.

The organopolysiloxane in the silicone base (D) must have at least two curable groups in its molecule. As used herein, a curable group is defined as any hydrocarbon group that is capable of reacting with itself or another hydrocarbon group, or alternatively with a crosslinker to crosslink the organopolysiloxane. This crosslinking results in a cured organopolysiloxane. Representative of the types of curable organopolysiloxanes that can be used in the silicone base are the organopolysiloxanes that are known in the art to produce silicone rubbers upon curing. Representative, non-limiting examples of such organopolysiloxanes are disclosed in “Encyclopedia of Chemical Technology”, by Kirk-Othmer, 4^{th} Edition, Vol. 22, pages 82-142, John Wiley & Sons, NY which is hereby incorporated by reference. Typically, organopolysiloxanes can be cured via a number of crosslinking mechanisms employing a variety of cure groups on the organopolysiloxane, cure agents, and optional crosslinking agent. While there are numerous crosslinking mechanisms, three of the more common crosslinking mechanisms used in the art to prepare silicone rubbers from curable organopolysiloxanes are free radical initiated crosslinking, hydrosilylation or addition cure, and condensation cure. Thus, the curable organopolysiloxane can be selected from, although not limited to, any organopolysiloxane capable of undergoing anyone of these aforementioned crosslinking mechanisms. The selection of components (D), (E), and (F) are made consistent with the choice of cure or crosslinking mechanisms. For example if hydrosilylation or addition cure is selected, then a silicone base comprising an organopolysiloxane with at least two vinyl groups (curable groups) would be used as component (D′), an organohydrido silicon compound would be used as component (E), and a platinum catalyst would be used as component (F). For condensation cure, a silicone base comprising an organopolysiloxane having at least 2 silicon bonded hydroxy groups (ie silanol, considered as the curable groups) would be selected as component (D) and a condensation cure catalyst known in the art, such as a tin catalyst, would be selected as component (F). For free radical initiated crosslinking, any organopolysiloxane can be selected as component (D), and a free radical initiator would be selected as component (F) if the combination will cure within the time and temperature constraints of the vulcanization of the organopolysiloxane. Depending on the selection of component (F) in such free radical initiated crosslinking, any alkyl group, such as methyl, can be considered as the curable groups, since they would crosslink under such free radical initiated conditions.

Further description of the silicone phase components, that is components (D), (E), and (F) suitable for use in the present invention can be found in U.S. Pat. Nos. 4,942,202, 5,010,137, and 5,171,787, WO2003/104322 and WO2003/104323, which are hereby incorporated by reference.

The quantity of the silicone phase, as defined herein as the combination of components (D), (E) and (F), used can vary depending on the amount of FKM elastomer (A) used. However, it is typical to use levels of FKM elastomer (A) of 30 to 95 wt. %, alternatively, 50 to 90 wt. %, or alternatively 60 to 80 wt. % based on the total weight of components (A) through (F).

It is also convenient to report the weight ratio of fluorocarbon elastomer (A) to the silicone base (D) which typically ranges from 95:5 to 30:70, alternatively 90:10 to 40:60, alternatively 80:20 to 40:60.

In addition to the above-mentioned major components (A) through (F), a minor amount (i.e., less than 50 weight percent of the total composition) of one or more optional additive (G) can be incorporated in the fluorocarbon—silicone elastomer base composition. These optional additives can be illustrated by the following non-limiting examples: extending fillers such as quartz, calcium carbonate, and diatomaceous earth; pigments such as iron oxide and titanium oxide; fillers such as carbon black and finely divided metals; heat stabilizers such as hydrated cerric oxide, calcium hydroxide, magnesium oxide; and flame retardants such as halogenated hydrocarbons, alumina trihydrate, magnesium hydroxide, wollastonite, organophosphorous compounds and other fire retardant (FR) materials, handling additives, and other additives known in the art. These additives are typically added to the final fluorocarbon—silicone elastomeric base composition after cure of the silicone phase, but they may also be added at any point in the preparation provided they do not interfere with the vulcanization mechanism

The fluorocarbon—silicone elastomer base can be prepared by mixing in any device that is capable of uniformly and quickly dispersing the components (B) through (G) with (A) the FKM elastomer. Typically the mixing is done by an extrusion process such as that conducted on a twin-screw extruder. The order of mixing components (A) through (G) can vary. In one embodiment, components (A) (B), and (C) are first mixed to prepare a modified fluorocarbon elastomer, such as described in WO2003/104322, and then mixed with the silicone phase components (D), (E), and (F). Alternatively, the mixing can occur via an extrusion process, such as taught in WO2003/104323, which is hereby incorporated by reference. In this case, the order of mixing is not critical.

Once components (A) through (G) are selected and mixed, the organopolysiloxane of component (D) is cured by a vulcanization process to form the fluorocarbon—silicone elastomeric base composition (i). The vulcanization can occur statically or dynamically. As used herein, dynamic vulcanization refers to a vulcanization process that occurs with continuous mixing of the composition. The continuous mixing can be the same mixing to effect the mixing of the components, i.e. be simultaneous with the mixing of the components. Alternatively, the vulcanization can occur statically. Static vulcanization refers to vulcanizing the organopolysiloxane after all the components (A)-(G) have been mixed. For example, the product of mixing components (A)-(G) can be simply subjected to a process to cure the organopolysiloxane, such as heating.

Component (ii) of the present invention is a fluoroplastic resin. The fluoroplastic resin can be any fluoroplastic having a melting point (Tₘ) above room temperature (RT) or 23° C. and a glass transition temperature (T_{g}) above room temperature or 23° C. “Glass transition temperature” means the temperature at which a polymer changes from a glassy vitreous state to a plastic state. The glass transition temperature can be determined by conventional methods, such as dynamic mechanical analysis (DMA) and Differential Scanning Calorimetry (DSC). Representative, non-limiting examples of FC resins can be found in summary articles of this class of materials such as in: “Vinylidene Fluoride-Based Thermoplastics (Overview and Commercial Aspects)”, J. S. Humphrey, Jr., “Tetrafluoroethylene Copolymers (Overview)”, T. Takakura, “Fluorinated Plastics Amorphous”, M. H. Hung, P. R. Resnick, B. E. Smart, W. H. Buck all of Polymeric Material Encylopedia, 1996 Version 1.1, CRC Press, NY; “Fluoropolymers”, K-L. Ring, A. Leder, and M Ishikawa-Yamaki, Chemical Economics Handbook-SRI International 2000, Plastics and Resins 580.0700A, all of which are hereby incorporated by reference. Thus, it is contemplated that the FC resin may be a homopolymer, copolymer, or terepolymer of the following fluorine comprising monomers selected from the list: tetrafluoroethylene, vinylidene difluoride, chlorotrifluoroethylene, hexafluoropropylene, and vinyl fluoride. These monomers can also be copolymerized with copolymerizable monomers including, but not limited to: vinyl compounds such as perfluoropropyl vinyl ether; olefin compounds such as ethylene, or hexafluoropropylene; or halogen containing polymerizable olefins such as bromotrifluoroethylene and 1-bromo-2,2-difluoroethylene. Commerically available examples are illustrated by but not limited to: poly(vinylidene difluoride), (PVDF); poly(ethylene-tetrafluoroethylene), (E-TEF); hexafluoropropylene/vinylidene fluoride, (HFP-PVDF); tetrafluoroethylene/hexafluoropropylene/vinylidene fluoride, (THV); and poly(ethylene-chlorotrifluoroethylene) (E-CTFE). It is anticipated that the fluoroplastic resin (ii), can be a mixture of any of the fluoroplastic resins discussed supra.

Component (iii) is a fluorocarbon elastomer cure agent. Component (iii) can be selected from any cure agent known in the art to effect the curing of fluorocarbon (FKM) elastomers. Typically, FKM elastomers are cured by one of three crosslinking mechanisms utilizing cure agents selected from diamine compounds, bis phenol-onium compounds, or peroxides. (Cure agents that are added as component (iii) are referred herein as fluorocarbon elastomer cure agents to distinguish these from the cure agents added to cure the silicone base component in the fluorocarbon—silicone elastomer base component (i)). Representative examples of such curing techniques, FKM cure agents, and typical additives are disclosed in “Encyclopedia of Chemical Technology”, by Kirk-Otluner, 4^{th} Edition, Vol. 8, pages 990-1005, John Wiley & Sons, NY, which is hereby incorporated by reference. Further, representative, non-limiting, examples of the cure techniques, and typical additives, that can be used are described in the technical information publications offered by major FKM elastomer suppliers, such as for example, Fluoroelastomers; Compounding Fluoroelastomers, and Fluoroelastomers Curing Fluoroelastomers by Dyneon, as shown at www.dyneon.com (May, 2002). Representative, non-limiting examples of suitable cure agents include; benzyltriphenylphosphonium chloride, bisphenol AF (CAS# 1478-61-1), and 2,5-dimethyl-2,5-di(tert-butylperoxy)hexane (CAS# 78-63-7).

Additional components can be added in conjunction with component (iii) for the purpose of enhancing the cure of the fluorocarbon—silicone base elastomeric base component (i). These additional components can be any component or ingredient typically added to a FKM elastomer or FKM elastomer gum for the purpose of preparing a cured FKM elastomer composition. Typically, these components can be selected from acid acceptors, fillers, processing aids, and curatives. Many commercially available FKM elastomers can already comprise these additional components, such as provided by “Masterbatch” FKM elastomer commercial products. Alternatively, such additional components can be added to the fluorocarbon—silicone base elastomer composition prior to mixing with the fluoroplastic resin.

Non-limiting examples of the acid acceptors useful as an additive to component (iii) include; calcium hydroxide, magnesium oxide, lead oxide (Litharge), PbHPO₃ (Dyphos), calcium oxide, and zinc oxide. Fluorocarbon elastomer cure agents can be considered as any component added to the base FKM elastomer composition that enhances the cure of the FKM elastomer. Thus, fluorocarbon elastomer cure agents can comprise FKM curing agents, cure-promoters, and acid acceptors. Examples include FKM cure agents or combinations of FKM cure agents such as a bisphenol and a organic onium salt accelerator, for example bisphenol A or bisphenol AF with triphenylbenzylphosphonium chloride or diphenylbenzyl(diethylamine)phosphonium chloride; a polyfunctional organic amine or derivative of the amines such as a carbamate, for example hexamethylenediamine carbamate; and organic peroxides and cure promoters which act with the free radicals generated from decomposition of the peroxide to provide a more useful cure.

The amounts of components (i), (ii), and (iii) can vary, but typically the weight ratio of the fluorocarbon—silicone elastomeric base (i) to the fluoroplastic resin (ii) ranges from 2:98 to 70:30, or alternatively 5:95 to 75:25. The amount of fluorocarbon elastomer cure agent (iii) added can vary depending on the selection of the specific cure agent, and its method of addition. Typically, the amount of fluorocarbon elastomer cure agent added will be 0.5 to 20, alternatively 1 to 10 weight percent of the total of (i), (ii) and (iii) used in the reaction mixture.

Components (i), (ii), and (iii) can be reacted by simply combining these components using mixing techniques known in the art for handling such materials. These techniques include batch or continuous mixing. Thus, mixing can be effected in mixers, Banbury mixer, kneader, roller, or extrusion process. Preferably, mixing of components (i), (ii), and (iii) occurs via an extrusion process, such as provided by a twin-screw extruder. Heating the components during the mixing process is provided to melt the fluoroplastic and react the mixture. Heating temperatures are determined by the selection of the fluoroplastic and FKM cure chemistry.

In one embodiment, of the present inventive method, components (i) and (iii) are uniformly mixed first to form a FKM compound. Component (ii) is mixed with a FKM compound in the mixing step.

The present invention further provides a method for preparing a fluoroplastic composition comprising;

I) mixing
i) a fluorocarbon—silicone elastomeric base,
ii) a fluoroplastic resin, and
iii) a fluorocarbon elastomer cure agent, then

II) vulcanizing the fluorocarbon—silicone elastomer base.

Steps (I) and (II) can be effected by the mixing and vulcanization steps discussed supra.

In one embodiment, of the present inventive method, components (i) and (iii) are uniformly mixed first to form a FKM compound. Component (ii) is mixed with a FKM compound in the mixing step (I) and vulcanized in step (II).

Additional components can be added to the fluoroplastic compositions of the present invention. These include blending other fluoroplastics, fluoroplastic silicone compositions or other fluoroplastic compositions into the fluoroplastic composition of the present invention. These additional components can also be any component or ingredient typically added to a fluoroplastics. Typically, these components can be selected from fillers and processing aids.

A fluoroplastic composition of the present invention can be processed by conventional techniques, such as extrusion, vacuum forming, injection molding, blow molding or compression molding, to fabricate plastic parts. Moreover, these compositions can be re-processed (recycled) with little or no degradation of mechanical properties. These novel fluoroplastic elastomers find utility in the fabrication of wire and cable insulation, such as plenum wire, automotive and appliance components, belts, hoses, construction seals and in general rubber applications.

### EXAMPLES

The following examples are presented to further illustrate the compositions and method of this invention, but are not construed as limiting the invention, which is delineated in the appended claims. All parts and percentages in the examples are on a weight basis and all measurements were obtained at approximately 23° C., unless otherwise indicated.

Materials

GP-70 is a silicone rubber base marketed by Dow Corning Corporation as Silastic® GP-70 Silicone Rubber.
LCS-755 is a silicone rubber base marketed by Dow Corning Corporation as Silastic® LCS-755 Silicone Rubber.
TRIG 101 is 2,5-dimethyl-2,5-di(tert-butylperoxy)hexane (CAS# 78-63-7) marketed by Akzo Nobel Chemicals, Inc. as TRIGONOX® 101.
VAROX is 2,5-dimethyl-2,5-di(tert-butylperoxy)hexane on an inert filler marketed by R. T. Vanderbilt, Company, Inc. as VAROX® DBPH-50.
COMPATIBILIZER 1 is a hydroxy end-blocked methylvinylsiloxane oligomer having a viscosity of about 35 mPa-s and containing 30% —CH═CH₂ groups and 3% OH groups.
TAIC is Triallyl-1,3,5-triazine-2,4,6-(1H,3H,5H)-trione (CAS# 1025-15-6), also known as triallyl isocyanurate, marketed by Aldrich Chemical Company, Inc.
ZnO is zinc oxide USP powder (CAS# 1314-13-2) C. P. Hall and the Zinc Corporation of America.
VC-20 is a masterbatch made from 67% of a copolymer of vinylidene fluoride and hexafluoropropene (CAS# 9011-17-0) and 33% benzyltriphenylphosphonium chloride
(CAS# 1100-88-5) and marketed by Dupont Dow Elastomers, LLC as Viton™ Curative No. 20.
VC-30 is a masterbatch made from a copolymer of vinylidene fluoride and hexafluoropropene (CAS# 9011-17-0), a terpolymer of vinylidene fluoride, hexafluoropropene, and tetrafluoroethene (CAS# 25190-89-0), Bisphenol AF (CAS# 1478-61-1), and 4,4′-dichlorodiphenyl sulfone (CAS# 80-07-9) and marketed by Dupont Dow Elastomers, LLC as Viton™ Curative No. 30.
CRI-ACT-45 is a 45% active dispersion of a 2/1 ration of Ca(OH)2 and Magnesium Oxide on fluoroelastomer supplied by Cri-Tech, a division of IMMIX Technologies, LLC.
G902 is 1-Propene, 1,1,2,3,3,3-hexafluoro-polymer with 1,1-difluoroethene and tetrafluoroethene Iodine modified fluoroelastomer (CAS# 25190-89-0) and is marketed by Daikin America, Inc. as DAI-EL™ Fluoroelastomer G-902.
B-202 is made from a terpolymer of vinylidene fluoride, hexafluoropropene, and tetrafluoroethene (CAS# 25190-89-0) and marketed by Dupont Dow Elastomers, LLC as Viton™ B-202.
COMPOUND 1 is a fluorocarbon—silicone base elastomeric composition prepared using a 40 mm BP Process Equipment twin-screw extruder with the processing sections heated at 150° C. and 200° C. and a screw speed of 300 rpm at an output rate of 82 kg/hr. The process began with the addition of a silicone compound consisting of LCS-755 (100 parts), ZnO (5 part) and Varox (0.5 parts) at a feed rate of 788 grams/minute, followed by a fluorocarbon elastomer (G902) to the extruder at a feed rate of 546 grams/minute. The resulting fluorocarbon base elastomeric composition obtained from the extruder was compounded on a mill until uniform with 5 parts of ZnO, 4 parts of TAIC, and 3 parts VAROX per 100 parts of FKM.
COMPOUND 2 is a fluorocarbon—silicone base elastomeric composition prepared using a 40 mm Werner and Pfleiderer twin-screw extruder with the processing sections heated at 150° C. and a screw speed of 400 rpm at an output rate of 80 kg/hr prepared according to the procedure in WO2003104322A1 Example 1 using B202 (100 parts), COMPATIBILIZER 1 (2.42 parts), TRIG 101 (0.6 parts), GP-70 (65.76 parts) and TRIG 101 (1.98 parts). The resulting fluorocarbon base elastomeric composition obtained from the extruder was compounded in a banbury mixer then on a mill until uniform with 3 parts of VC-20, 3.8 parts of VC-30, and 20 parts of Cri-Act-45 to give 6 parts of calcium hydroxide and 3 parts of magnesium oxide per 100 parts of FKM.
COMPOUND 3 is B202 compounded in a Banbury mixer then on a mill until uniform with 3 parts of VC-20, 3.8 parts of VC-30, and 20 parts of Cri-Act-45 to give 6 parts of calcium hydroxide and 3 parts of magnesium oxide per 100 parts of FKM.
THV220G is a fluorinated terpolymer of tetrafluoroethylene, hexafluoropropylene and vinylidene fluoride marketed by Dyneon, LLC as Dyneon™ THV 220G Fluorothermoplastic.
KYNAR 3150 is a polyvinylidene fluoride (PVDF) copolymer and is marketed by ATOFINA Chemicals, Inc. as Kynar Flex® copolymer series 3120.
   Testing

The tensile, elongation, and 100% modulus properties of the fluoroplastic compositions were measured by a procedure is based on ASTM D 412. Shore A Durometer was measured by a procedure is based on ASTM D 2240.

### Example 1

COMPOUND 1 (211 g) and THV200G (285 g) were added to a 310 ml Haake mixer equipped with banbury rollers at 150° C. and 125 rpm (revolutions per minute). After a torque increase, the material temperature was about 220° C. The fluoroplastic elastomeric composition was removed at 9 minutes.

Upon cooling, compression molded to give a Shore A Durometer of 80, a Tensile Strength of 13.9 MPa, an Elongation 419%.

### Example 2

COMPOUND 2 (150 g) and KYNAR 3120 (285 g) were added to a 310 ml Haake mixer equipped with banbury rollers at 120° C. and 125 rpm (revolutions per minute). After a torque increase, the material temperature was about 220° C. The fluoroplastic elastomeric composition was removed at 17 minutes.

Upon cooling, compression molded to give a Shore D Durometer of 46, a Tensile Strength of 4.0 MPa, an Elongation 471%.

### Example 3

COMPOUND 3 (150 g) and KYNAR 3120 (285 g) were added to a 310 ml Haake mixer equipped with banbury rollers at 120° C. and 125 rpm (revolutions per minute). After a torque increase, the material temperature was about 220° C. The fluoroplastic elastomeric composition was removed at 17 minutes.

Upon cooling, compression molded to give a Shore D Durometer of 46, a Tensile Strength of 2.9 MPa, an Elongation 227%.

1. A fluoroplastic composition comprising the reaction product from mixing;
i) a fluorocarbon—silicone elastomeric base,
ii) a fluoroplastic resin, and
iii) a FKM cure agent.

2. The composition of claim 1 wherein the fluorocarbon—silicone elastomeric base is prepared by a process comprising mixing a curable organopolysiloxane with a fluorocarbon elastomer and then vulcanizing the organopolysiloxane.

3. The composition of claim 1 wherein the fluoroplastic resin has a melt point above 25° C.

4. The composition of claim 1 wherein the weight ratio of i) to ii) is from 2:98 to 70:30.

5. A method for preparing a fluoroplastic composition comprising;
I) mixing
i) a fluorocarbon—silicone elastomeric base,
ii) a fluoroplastic resin, and
iii) a fluorocarbon elastomer cure agent,
II) vulcanizing the fluorocarbon—silicone elastomer base.

6. The compositions of claim 1 wherein the fluorocarbon—silicone elastomeric base and the fluorocarbon elastomers cure agent are mixed first.

7. An article of manufacture comprising the fluoroplastic composition of claims 1-6.
